(19) United States
(12) Patent Application Publication
(10) Pub. No.: US 2025/0065924 A1
(43) Pub. Date: Feb. 27, 2025

(54) Method for at Least Highly Automated Driving and for Infrastructure-based Assistance of a Motor Vehicle within a Parking Area

(71) Applicant: Robert Bosch GmbH, Stuttgart-Feuerbach (DE)

(72) Inventors: Stefan Nordbruch, Leonberg (DE); Nico Latsch, Oppenweiler (DE); Felix Hess, Benningen (DE); Michael Gabb, Gaufelden (DE); Carsten Hammerling, Gartringen (DE); Sascha Muhlbrandt, Wiernsheim (DE); Sebastian Hahn, Sindelfingen (DE)

(73) Assignee: Robert Bosch GmbH, Stuttgart-Feuerbach (DE)

(21) Appl. No.: 18/812,365

(22) Filed: Aug. 22, 2024

(30) Foreign Application Priority Data
Aug. 22, 2023 (DE) 10 2023 122 474.3

(51) Int. Cl. B60W 60/00; B60W 30/06

(52) U.S. Cl. CPC B60W 60/005; B60W 30/06; B60W 60/001; B60W 2556/45; B60W 2756/10

(57) ABSTRACT

A method for driving a motor vehicle within a parking area includes providing the motor vehicle with a motor vehicle AVP system, and operating the motor vehicle in a second AVP operating mode by way of the motor vehicle AVP system, with the motor vehicle driving according to an AVP type 2 within the parking area with the assistance of an infrastructure AVP. A handover process is carried out to switch the motor vehicle from the second AVP operating mode to a first AVP operating mode when a handover region of the parking area is reached by the motor vehicle, with the switching occurring when the handover process has been completed. The motor vehicle is operated in the first AVP operating mode after switching, with the motor vehicle driving according to the AVP type 1 within the parking area.

### CROSS-REFERENCE TO RELATED APPLICATION

This application claims the benefit of the filing date under 35 U.S.C. § 119(a)-(d) of German Patent Application No. 10 2023 122 474.3, filed on Aug. 22, 2023.

### FIELD OF THE INVENTION

The invention relates to a method for at least highly automated driving of a motor vehicle within a parking area, to a method for infrastructure-based assistance of a motor vehicle during an at least highly automated journey within a parking area, to an AVP system for a motor vehicle, to a motor vehicle, to an AVP system for an infrastructure, to a computer program and to a machine-readable storage medium.

### BACKGROUND

The abbreviation “AVP” stands for “Automated Valet Parking”. An AVP process comprises, for example, at least highly automated guidance of the AVP motor vehicle from a drop zone, also called a drop-off position or drop-off zone, to a parking position and, for example, at least highly automated guidance of the motor vehicle from a parking position to a pick-up position, also called a pick-up zone. At the drop-off position, i.e. the drop zone, a driver of the motor vehicle drops off the motor vehicle for an AVP process. At a pick-up position, i.e. the pick-up zone, the motor vehicle is picked up after the end of the AVP process. Thus, an AVP process starts in particular at the drop zone. An AVP process therefore ends in particular at the pick-up zone. The pick-up zone can be the same as or different from the drop zone. An AVP motor vehicle is therefore a motor vehicle that can participate in an AVP process.

The published patent application DE 10 2012 222 562 A1 shows a system for managed parking spaces for transferring a vehicle from a starting position to a target position.

An AVP process can be an AVP process according to one of the following AVP types: AVP type 1, AVP type 2, and AVP type 3. AVP type 1 denotes a motor-vehicle-centric AVP process. The primary responsibility for the AVP process lies with the motor vehicle. AVP type 2 denotes an infrastructure-centric AVP process. The primary responsibility for the AVP process lies with the infrastructure, i.e. the AVP system. AVP type 3 denotes an AVP process split between the motor vehicle and the infrastructure. Here, a primary responsibility for the AVP process is split between the motor vehicle and the AVP system.

When the motor vehicle drives according to AVP type 2, provision is made for the infrastructure to detect an object and/or an event and to react accordingly to a detected object and/or a detected event. For this purpose, a plurality of environmental sensors are arranged within the parking area, the environmental sensor data from which are used as a basis for object detection or event detection.

When the motor vehicle drives according to AVP type 1, provision is usually made for the motor vehicle to detect an object and/or an event on the basis of its own environmental sensors and to react accordingly to a detected object and/or a detected event. In other words, driving according to AVP type 1 does not usually require any environmental sensors in the parking area.

However, there may be regions within the parking area that are complex and/or that may lead to situations that are easier to cope with by driving according to AVP type 2 using environmental sensors in the parking area than if the motor vehicle relies only on its own environmental sensors. Such regions include, for example, a drop zone, i.e. a region where a driver parks his motor vehicle for the AVP process, or parking bays or a region in front of a stairwell or an elevator, since more people can be expected here at once than in the rest of the parking garage.

Equipping all regions of the parking area, i.e. even those regions that the motor vehicle could easily drive through at least in a highly automated manner even without environmental sensors in the parking area, with environmental sensors is technically complex and expensive.

### SUMMARY

A method for driving a motor vehicle within a parking area includes providing the motor vehicle with a motor vehicle AVP system, and operating the motor vehicle in a second AVP operating mode by way of the motor vehicle AVP system, with the motor vehicle driving according to an AVP type 2 within the parking area with the assistance of an infrastructure AVP. A handover process is carried out to switch the motor vehicle from the second AVP operating mode to a first AVP operating mode when a handover region of the parking area is reached by the motor vehicle, with the switching occurring when the handover process has been completed. The motor vehicle is operated in the first AVP operating mode after switching, with the motor vehicle driving according to the AVP type 1 within the parking area.

### BRIEF DESCRIPTION OF THE DRAWINGS

The invention will be explained in more detail below with reference to exemplary embodiments, in which:

FIG. 1 shows a flowchart of a method according to a first aspect;

FIG. 2 shows a flowchart of a method according to a second aspect;

FIG. 3 shows a schematic diagram of a motor vehicle AVP system;

FIG. 4 shows a block diagram of an infrastructure AVP system;

FIG. 5 shows a block diagram of a machine-readable storage medium;

FIG. 6 shows a schematic diagram of a parking area according to a first embodiment;

FIG. 7 shows a schematic diagram of a parking area according to a second embodiment;

FIG. 8 shows a schematic diagram of a parking area according to a third embodiment;

FIG. 9 shows a block diagram of a process flow of an AVP process;

FIG. 10 shows a block diagram of a first portion of the process flow of FIG. 9;

FIG. 11 shows a block diagram of a second portion of the process flow of FIG. 9;

FIG. 12 shows a block diagram of a third portion of the process flow of FIG. 9; and

FIG. 13 shows a block diagram of a fourth portion of the process flow of FIG. 9.

### DETAILED DESCRIPTION OF THE EMBODIMENTS

The same reference signs can be used for the same features below. The embodiments and exemplary embodiments described here can be combined in any manner with one another, even if this is not explicitly described.

The present invention allows a motor vehicle to drive within a parking area in an at least highly automated manner according to AVP type 2 or according to AVP type 1.

According to the concept described here, provision is made for the motor vehicle to be driven within the parking area either according to AVP type 2 or in an at least highly automated manner according to AVP type 1 for separate regions of the parking area. This means that there are one or more regions within the parking area, within which the motor vehicle is intended to drive in an at least highly automated manner according to AVP type 2. This means that there are one or more regions within the parking area, within which the motor vehicle is intended to drive in an at least highly automated manner according to AVP type 1.

Before switching from at least highly automated driving according to AVP type 2 to at least highly automated driving according to AVP type 1 or vice versa, a handover process takes place, wherein the motor vehicle may switch from the second AVP operating mode to the first AVP operating mode or vice versa only after successful execution. The handover process required for switching is carried out when a handover region of the parking area is reached.

Thus, it is possible to efficiently cause the motor vehicle to drive in an at least highly automated manner within the framework of an AVP process according to different AVP types: in the present case, according to AVP type 2 and, after switching, according to AVP type 1 and in particular back to AVP type 2 again.

A region within which the motor vehicle drives according to AVP type 1 does not need to be equipped with environmental sensors that monitor this region. The reason is that AVP type 1 is motor-vehicle-centric driving. The responsibility for driving lies solely with the motor vehicle AVP system. For driving, the motor vehicle uses its own environmental sensors that capture an environment of the motor vehicle. Based on this capture, the motor vehicle drives according to AVP type 1.

A region within which the motor vehicle drives according to AVP type 2 must be equipped with environmental sensors that monitor this region. The reason is that AVP type 2 is infrastructure-centric driving. The responsibility for driving lies solely with the infrastructure, in this case with the infrastructure AVP system. So that the motor vehicle can drive in an infrastructure-centric manner according to AVP type 2, certain information (infrastructure assistance data) must be sent from the infrastructure to the motor vehicle. In order to be able to determine this information, information is required about the region within which the motor vehicle is intended to drive according to AVP type 2. This information is determined, for example, using one or more environmental sensors that monitor this region. Thus, for example, the infrastructure knows whether there is a potential collision object for the motor vehicle within the region and can accordingly determine a target trajectory for circumventing the collision object for the motor vehicle and send it to the motor vehicle.

Thus, regions of the parking area can be equipped with environmental sensors that monitor these regions within which the motor vehicle drives in an at least highly automated manner according to AVP type 2. Thus, it is possible to provide regions of the parking area which are not equipped with environmental sensors, that is to say are not monitored by environmental sensors in the parking area. This is not necessary, since the motor vehicle is intended to drive in an at least highly automated manner according to AVP type 1 within these regions.

Thus, installation effort for environmental sensors within the parking area can be efficiently reduced compared to the case in which the motor vehicle drives in an at least highly automated manner exclusively according to AVP type 2 within the parking area, since the motor vehicle requires environmental sensors outside the motor vehicle for this purpose.

In addition, fewer environmental sensors are required compared to the case in which the motor vehicle drives in an at least highly automated manner exclusively according to AVP type 2 within the parking area.

A parking area in the sense of the description can also be referred to as a parking space and serves as a parking space for vehicles. In particular, the parking area thus forms a contiguous area which has a plurality of parking places (in the case of a parking area on private land) or parking zones (in the case of a parking area on public land). The parking area may be included in a parking garage according to one embodiment. In particular, the parking area is included in a garage.

The abbreviation “AVP” stands for “Automated Valet Parking”. An AVP process comprises, for example, at least highly automated guidance of the motor vehicle from a drop zone, also called a drop-off position, to a parking position and, for example, at least highly automated guidance of the motor vehicle from a parking position to a pick-up position, also called a pick-up zone. At the drop-off position, i.e. the drop zone, a driver of the motor vehicle drops off the motor vehicle for an AVP process. At a pick-up position, i.e. the pick-up zone, the motor vehicle is picked up after the end of the AVP process. Thus, an AVP process starts in particular at the drop zone. An AVP process therefore ends in particular at the pick-up zone. The pick-up zone can be the same as or different from the drop zone.

An AVP motor vehicle is therefore a motor vehicle that can participate in an AVP process. If motor vehicle is written herein, it should be read that this is an AVP motor vehicle, even if the term “AVP” is not explicitly used.

The AVP process is carried out on the infrastructure side using or by way of the AVP system for an infrastructure and is carried out on the motor vehicle side using or by way of the AVP system for a motor vehicle.

An AVP process can be an AVP process according to one of the following AVP types: AVP type 1, AVP type 2, and AVP type 3. However, the AVP types can also change within an AVP process. This means, for example, that one part of an AVP process is carried out according to AVP type 1 and another part of the AVP process is carried out according to an AVP type 2 or AVP type 3. This means, for example, that an AVP process can be divided into partial AVP processes which are each carried out according to one of the AVP types 1, 2 and 3.

AVP type 1 denotes a motor-vehicle-centric AVP process. The primary responsibility for the AVP process lies with the motor vehicle, i.e. the motor vehicle AVP system.

AVP type 2 denotes an infrastructure-centric AVP process. The primary responsibility for the AVP process lies with the infrastructure, i.e. the infrastructure AVP system.

AVP type 3 denotes an AVP process split between the motor vehicle and the infrastructure. Here, a primary responsibility for the AVP process is split between the motor vehicle, i.e. the motor vehicle AVP system, and the AVP system.

An AVP process comprises the following operations or functions:
1. Determining a target position within the parking area for the motor vehicle.
2. Planning a route from a starting position that is included in the parking area to the target position.
3. Detecting an object and/or an event and reacting accordingly to a detected object and/or a detected event.
4. Locating the motor vehicle within the parking area.
5. Calculating a target trajectory for the motor vehicle based on the planned route.
6. Controlling lateral and longitudinal guidance of the motor vehicle based on the calculated target trajectory.

The following table indicates which of these operations or functions are carried out by the motor vehicle, i.e. the motor vehicle AVP system, or the infrastructure AVP system, depending on the AVP type, where “I” stands for “infrastructure”, i.e. the infrastructure AVP system, and “K” stands for “motor vehicle”, with the result that “I” indicates that the process is carried out by the AVP system and “K” indicates that the process is carried out by the motor vehicle:

TABLE 1
Functions by AVP type

| | AVP | AVP | AVP |
|---|---|---|---|
| Functions | type 1 | type 2 | type 3 |
| Determining a target position | I & K | I | I |
| within the parking area for the | | | |
| motor vehicle. | | | |
| Planning a route from a starting | K | I | I |
| position that is included in the | | | |
| parking area to the target | | | |
| position. | | | |
| Detecting an object and/or an | K (& | I | I & K |
| event and reacting accordingly | optionally | | |
| to a detected object and/or a | I) | | |
| detected event. | | | |
| Locating the motor vehicle | K | I | K |
| within the parking area. | | | |
| Calculating a target trajectory | K | I | K |
| for the motor vehicle based on | | | |
| the planned route. | | | |
| Controlling lateral and | K | K | K |
| longitudinal guidance of the | | | |
| motor vehicle based on the | | | |
| calculated target trajectory. | | | |

The table above therefore indicates for each function, specifically for each AVP type, whether the function is performed by the infrastructure, i.e. by the infrastructure AVP system, or by the motor vehicle, i.e. by the motor vehicle AVP system. In some cases, provision may be made for the function to be performed by both the infrastructure AVP system and the motor vehicle.

With regard to object and event detection for AVP type 1, provision may optionally be made for the infrastructure AVP system of the infrastructure to also perform this function in addition to the motor vehicle.

AVP types 1, 2 and 3 described here are described in further detail in ISO Standard 23374-1:2021(E).

The motor vehicle is an at least highly automated motor vehicle. Such a motor vehicle is configured for at least highly automated guidance. Highly automated guidance corresponds to an automation level 3 as defined by the Federal Highway Research Institute (BASt).

The fact that the motor vehicle is configured at least for highly automated guidance includes the case where the motor vehicle is configured for highly automated guidance as well as for fully automated guidance and for autonomous guidance. Fully automated guidance corresponds to an automation level 4 as defined by the BASt.

Highly automated guidance means that, for a certain period of time in a specific situation (for example: driving on a freeway, driving within a parking area, overtaking an object, driving within a lane defined by lane markings), longitudinal and lateral guidance of the motor vehicle is automatically controlled. A driver of the motor vehicle does not have to manually control the longitudinal and lateral guidance of the motor vehicle himself. The driver does not have to permanently monitor the automatic control of the longitudinal and lateral guidance in order to be able to intervene manually if necessary. If necessary, a takeover request to take over the control of the longitudinal and lateral guidance is automatically output to the driver, in particular with a sufficient time reserve. This means that the driver must potentially be able to take over the control of the longitudinal and lateral guidance. Limits of the automatic control of the lateral and longitudinal guidance are automatically recognized. With highly automated guidance, it is not possible to automatically bring about a risk-minimized state in every initial situation.

The wording “to take over the control of the longitudinal and lateral guidance” can also be replaced by the wording “to take over the longitudinal and lateral guidance”.

Fully automated guidance means that, in a specific situation (for example: driving on a freeway, driving within a parking area, overtaking an object, driving within a lane defined by lane markings), longitudinal and lateral guidance of the motor vehicle is automatically controlled. A driver of the motor vehicle does not have to manually control the longitudinal and lateral guidance of the motor vehicle himself. The driver does not have to monitor the automatic control of the longitudinal and lateral guidance in order to be able to intervene manually if necessary. Before the automatic control of the lateral and longitudinal guidance is stopped, the driver is automatically prompted to take over the driving task (control of the lateral and longitudinal guidance of the motor vehicle), in particular with a sufficient time reserve. If the driver does not take over the driving task, there is an automatic return to a risk-minimized state. Limits of the automatic control of the lateral and longitudinal guidance are automatically recognized. In all situations, it is possible to automatically return to a risk-minimized system state.

Autonomous guidance or driving means that longitudinal and lateral guidance of the motor vehicle is automatically controlled in all situations and not only in one or more specific situations. The driver is no longer necessary as a fallback level. The motor vehicle can therefore drive without a driver. Autonomous guidance corresponds to an automation level 5 according to SAE (J3016), where SAE stands for “Society of Automotive Engineers”.

In one embodiment of the method according to the first aspect, provision is made, before operating the motor vehicle in the second AVP operating mode, for an AVP initialization process to be carried out by the motor vehicle AVP system, wherein the motor vehicle is switched to the second AVP operating mode after successful completion of the AVP initialization process.

This provides, for example, the technical advantage that it can be efficiently ensured that the motor vehicle is ready to switch to the second AVP operating mode and to be driven in an at least highly automated manner according to AVP type 2 by the motor vehicle AVP system.

In one embodiment of the method according to the first aspect, provision is made for the carrying out of the AVP initialization process to comprise locating the motor vehicle on the motor vehicle side by way of the motor vehicle AVP system in order to determine a current pose of the motor vehicle, wherein the current pose of the motor vehicle is sent by the motor vehicle AVP system to the infrastructure AVP system, so that the infrastructure AVP system can check the pose of the motor vehicle, as determined on the motor vehicle side, in order to identify the motor vehicle, wherein, for a successful end of the AVP initialization process, a confirmation of successful identification of the motor vehicle by the infrastructure AVP system must be received on the motor vehicle side by the motor vehicle AVP system.

This provides, for example, the technical advantage that the infrastructure AVP system can efficiently identify the motor vehicle by determining the current pose of the motor vehicle by checking the pose determined on the motor vehicle side. Successful identification of the motor vehicle by the infrastructure AVP system is an important prerequisite that should or must be met before the infrastructure AVP system assumes responsibility for the at least highly automated driving according to AVP type 2. In other words, the infrastructure AVP system must know which motor vehicle it should assume responsibility for before it assumes responsibility. This is particularly useful, in particular, when there are multiple motor vehicles that want to carry out an AVP process within the parking area.

In one embodiment of the method according to the first aspect, provision is made for a digital map of the parking area to be received from the infrastructure AVP system by the motor vehicle AVP system, on the basis of which map the motor vehicle is located in order to determine the current pose of the motor vehicle within the digital map. This provides, for example, the technical advantage that the motor vehicle can be efficiently located, with the result that the current pose can be efficiently determined.

In one embodiment of the method according to the first aspect, provision is made, during the at least highly automated driving according to AVP type 2, for the motor vehicle to be continuously located on the motor vehicle side by the motor vehicle AVP system, on the basis of which the motor vehicle is driven in an at least highly automated manner according to AVP type 2 by the motor vehicle AVP system.

This provides, for example, the technical advantage that the at least highly automated driving according to AVP type 2 can be carried out efficiently. In particular, this provides the technical advantage that the motor vehicle knows where it is located within the parking area. The motor vehicle AVP system can efficiently use this knowledge for the at least highly automated driving according to AVP type 2.

In one embodiment of the method according to the first aspect, provision is made, during the at least highly automated driving according to AVP type 2, for the motor vehicle to be continuously located on the motor vehicle side by the motor vehicle AVP system, on the basis of which the reaching of the handover region is detected on the motor vehicle side by the motor vehicle AVP system, as a result of which the handover process is started by the motor vehicle AVP system.

This provides, for example, the technical advantage that the motor vehicle can efficiently know when it reaches the handover region, with the result that the motor vehicle AVP system can itself initiate, i.e. start, the handover process.

In one embodiment of the method according to the first aspect, provision is made for the carrying out of the handover process to comprise checking handover preconditions, which must be fulfilled for switching, on the motor vehicle side by way of the motor vehicle AVP system, wherein, if checking is successful on the motor vehicle side, a switching request is sent to the infrastructure AVP system by the motor vehicle AVP system.

This provides, for example, the technical advantage that switching is only carried out when certain conditions are met, which results in an increase in safety. The technical advantage of checking the handover preconditions on the motor vehicle side is, in particular, that the motor vehicle itself checks whether the motor vehicle is actually ready for switching. The fact that, if checking is successful, the motor vehicle AVP system reports this to the infrastructure AVP system has the technical advantage, for example, that the infrastructure AVP system efficiently knows that the motor vehicle is ready for switching from its point of view.

One handover precondition is, for example, that the motor vehicle must be approved for AVP and in particular for AVP type 1 and AVP type 2.

One handover precondition is, for example, that the motor vehicle must be ready for switching and/or the at least highly automated driving according to AVP type 1. Being ready means, in particular, that all the components of the motor vehicle required for the at least highly automated driving must be ready. Being ready means, in particular, that there is no fault or that no fault has occurred.

One handover precondition is, for example, is that the infrastructure AVP system must be ready for switching. Being ready means, in particular, that all the components of the infrastructure AVP system required for switching must be ready. Being ready means, in particular, that there is no fault or that no fault has occurred.

In one embodiment of the method according to the first aspect, provision is made for the carrying out of the handover process to comprise receiving, on the motor vehicle side, a target position and a proposal of a route to the target position from the infrastructure AVP system by way of the motor vehicle AVP system, on the basis of which the motor vehicle is driven by the motor vehicle AVP system in an at least highly automated manner according to AVP type 1 after switching.

This provides, for example, the technical advantage that the motor vehicle can efficiently drive in an at least highly automated manner according to AVP type 1 after switching. The motor vehicle AVP system therefore knows where it is intended to drive the motor vehicle to. At the same time, the infrastructure AVP system transmitted a proposal of a route to the target position to the motor vehicle AVP system, with the result that the motor vehicle AVP system can efficiently plan the at least highly automated journey according to AVP type 1 based on this proposal.

A route to the target position is, for example, a route from a current position of the motor vehicle to the target position. A route to the target position is, for example, a route from a future position of the motor vehicle to the target position.

A target position can be, for example, a parking place or a parking bay of the parking area. A target position may be, for example, the beginning of a critical region from which the motor vehicle may no longer drive in an at least highly automated manner according to AVP type 1, but rather according to AVP type 2. Such a critical region is, for example, a region in front of a stairwell or an elevator, since more people can usually be expected here at once than in the remaining region of the parking area.

In one embodiment of the method according to the first aspect, provision is made, during the at least highly automated driving according to AVP type 1, for an environment of the motor vehicle to be captured on the motor vehicle side using a motor vehicle environmental sensor system, wherein, if an obstacle captured by the motor vehicle environmental sensor system is detected on the motor vehicle side, the proposed route is replanned on the motor vehicle side by the motor vehicle AVP system in order to avoid obstacles, with the result that the motor vehicle is driven to the target position by the motor vehicle AVP system, at least in a highly automated manner according to AVP type 1, based on the replanned route.

This provides, for example, the technical advantage that an obstacle on the proposed route does not result in the motor vehicle stopping in front of the obstacle and then no longer being able to continue the journey, which is referred to as a “dead lock”. Rather, according to this embodiment, provision is made for the motor vehicle AVP system to replan the proposed route, such that the motor vehicle can still drive to the target position in an at least highly automated manner according to AVP type 1 even in the event of an obstacle on the original route.

In one embodiment of the method according to the first aspect, provision is made, at the end of the handover process, for a specification from the infrastructure AVP system, as regards the AVP type according to which the motor vehicle is intended to continue to drive in an at least highly automated manner, to be received on the motor vehicle side by the motor vehicle AVP system, wherein the specification is followed by the motor vehicle AVP system on the motor vehicle side.

This provides, for example, the technical advantage that the infrastructure AVP system has the last word regarding switching. If it decides at the end of the handover process that the motor vehicle may not drive further in an at least highly automated manner according to AVP type 1, this will be communicated to the motor vehicle with the transmission of the corresponding specification. This means that the infrastructure AVP system is the entity that ultimately determines whether or not switching to the first AVP operating mode is allowed. This can mean, for example, that switching is possible from the point of view of the motor vehicle AVP system. Nevertheless, the motor vehicle AVP system will wait until the infrastructure AVP system explicitly specifies that it may switch to the first AVP operating mode. This makes it possible to efficiently increase safety for the motor vehicle and its surroundings.

In one embodiment of the method according to the second aspect, provision is made, before assisting the motor vehicle on the infrastructure side, for an AVP initialization process to be carried out by the infrastructure AVP system, wherein, at a successful end of the AVP initialization process, the infrastructure AVP system sends a first driving permit to the motor vehicle, as a result of which the latter may switch to the second AVP operating mode.

This provides, for example, the technical advantage that it can be efficiently ensured that everything is ready so that the motor vehicle can drive in an at least highly automated manner according to AVP type 2 before it actually drives away. The motor vehicle must not be switched to the second AVP operating mode and accordingly drive away until the first driving permit has been received. Here, too, the infrastructure AVP system is the entity that ultimately determines that the motor vehicle is allowed to drive away according to AVP type 2. If, for example, the motor vehicle AVP system comes to the decision that from its point of view everything is OK for driving away according to AVP type 2, it will not do so, but rather will first wait for the first driving permit from the infrastructure AVP system. This is because, for example, a situation could arise in which an environmental sensor system of the motor vehicle, i.e. a motor vehicle environmental sensor system, has not captured a possible collision object in its surroundings, which was, however, captured by infrastructure environmental sensors.

In one embodiment of the method according to the second aspect, provision is made for the carrying out of the AVP initialization process to comprise receiving, from the motor vehicle, a current pose of the motor vehicle, as determined on the motor vehicle side, by way of the infrastructure AVP system, wherein the motor vehicle is located by the infrastructure AVP system in order to determine a current pose of the motor vehicle on the infrastructure side, wherein the infrastructure AVP system compares the current pose determined on the infrastructure side with the current pose determined on the motor vehicle side in order to identify the motor vehicle, wherein, depending on the comparison, a confirmation of successful identification of the motor vehicle is sent by the infrastructure AVP system to the motor vehicle.

This provides, for example, the technical advantage that the infrastructure AVP system can efficiently identify the motor vehicle. The infrastructure AVP system checks the current pose determined on the motor vehicle side with the current pose determined on the infrastructure side. Only if there is a match, especially if there is a match within a predetermined tolerance range, is a confirmation of successful identification sent from the infrastructure AVP system to the motor vehicle AVP system. This confirmation requires successful running through or successful performance of the AVP initialization process.

In one embodiment of the method, provision is made for a digital map of the parking area to be sent by the infrastructure AVP system to the motor vehicle, on the basis of which map the motor vehicle can be located.

This provides, for example, the technical advantage of efficiently enabling the motor vehicle to efficiently locate itself within the digital map. This means that, according to this embodiment, the current pose of the motor vehicle determined on the motor vehicle side is related to the digital map of the parking area.

In one embodiment of the method, provision is made for the carrying out of the AVP initialization process to comprise checking, by way of the infrastructure AVP system, whether the motor vehicle can drive away without a collision, wherein the first driving permit is sent only if it is possible to drive away without a collision.

This provides, for example, the technical advantage of being able to efficiently ensure that the motor vehicle can drive away without a collision at the end of the AVP initialization process. If the motor vehicle AVP system thus receives the first driving permit from the infrastructure AVP system, it can assume that it can drive away without a collision.

Checking whether the motor vehicle can drive away without a collision is carried out, for example, using one or more environmental sensors of the parking area, by way of which an environment of the motor vehicle is captured in order to detect a potential collision object. If such a collision object is detected, no first driving permit is sent to the motor vehicle. Therefore, no first driving permit will be sent as long as such a potential collision object is present.

In one embodiment of the method according to the second aspect, provision is made for the carrying out of the handover process to comprise receiving a switching request from the motor vehicle by way of the infrastructure AVP system infrastructure system, wherein, in response to receiving the switching request, the infrastructure AVP system checks handover preconditions which must be fulfilled for switching, wherein, if checking is successful, a target position and a proposal of a route to the target position are determined by the infrastructure AVP system and sent to the motor vehicle.

This provides, for example, the technical advantage that the infrastructure AVP system can efficiently ensure that certain conditions, the handover preconditions, are met before the motor vehicle is allowed to switch to the first AVP operating mode. This means that it can be efficiently ensured on the infrastructure side that such a continued driving according to AVP type 1 is safe.

In one embodiment of the method according to the second aspect, provision is made, in the event of an unsuccessful end of the handover process, for a specification to be sent by the infrastructure AVP system to the motor vehicle indicating that the motor vehicle is intended to continue to drive in an at least highly automated manner according to AVP type 2. This provides, for example, the technical advantage that the motor vehicle can still continue the AVP process, even if the handover process was not successful. This is then done according to AVP type 2.

Statements made herein in connection with the method according to the first aspect apply analogously to the method according to the second aspect and vice versa. This means that the technical functionalities and features of the method according to the second aspect result from corresponding technical functionalities of the method according to the first aspect and vice versa. For example, sending and receiving in the sense of the description is sending and receiving via one or more communication networks. A communication network is, for example, a WLAN network or a mobile radio network.

The motor vehicle AVP system is configured, for example by virtue of programming, to execute a computer program according to a fifth aspect, which comprises instructions which, when the computer program is executed by a computer, cause the latter to carry out a method according to the first aspect.

The infrastructure AVP system is configured, for example by virtue of programming, to execute the computer program according to the fifth aspect, which comprises instructions which, when the computer program is executed by a computer, cause the latter to carry out a method according to the second aspect.

The method according to the first aspect and/or the method according to the second aspect is or are, for example, computer-implemented methods.

The motor vehicle comprises, for example, one or more environmental sensors. Such environmental sensors can also be called motor vehicle environmental sensors. Such environmental sensors are included, for example, in the motor vehicle AVP system. A motor vehicle environmental sensor system comprises, for example, one or more such environmental sensors.

The AVP system comprises, for example, one or more environmental sensors which are spatially distributed within the parking area. Such environmental sensors can be referred to, for example, as infrastructure environmental sensors. An infrastructure environmental sensor system comprises, for example, one or more such infrastructure environmental sensors.

An environmental sensor, i.e. a motor vehicle environmental sensor or an infrastructure environmental sensor, is, for example, one of the following environmental sensors: radar sensor, lidar sensor, image sensor, in particular image sensor of a video camera, for example image sensors of a stereo video camera, ultrasonic sensor, magnetic field sensor, infrared sensor.

In one embodiment of the method according to the first aspect, provision is made for the carrying out of the handover process to comprise receiving, on the motor vehicle side, a switching confirmation from the infrastructure AVP system by way of the motor vehicle AVP system.

In one embodiment of the method according to the second aspect, provision is made for the carrying out of the handover process to comprise sending a switching confirmation to the motor vehicle by way of the infrastructure AVP system.

In one embodiment, the motor vehicle AVP system comprises a control unit for at least highly automated control of lateral and longitudinal guidance of the motor vehicle.

According to the concept described here, provision is generally made, for example, for an AVP process to start in the second AVP operating mode and/or to end in the second AVP operating mode.

If it is written herein that the motor vehicle carries out a certain step or certain steps, this shall mean that these steps are carried out using the motor vehicle AVP system. The method steps of the method according to the first aspect are thus carried out by the motor vehicle AVP system.

Accordingly, the method steps of the method according to the second aspect are carried out using, in particular by, the infrastructure AVP system.

The term “transfer” can also be herein used instead of the term “handover”.

The infrastructure AVP system of the method according to the second aspect is the AVP system for an infrastructure, in particular a parking area, according to the fifth aspect. This means that the AVP system according to the fifth aspect can be referred to as an infrastructure AVP system if it is implemented in an infrastructure, in particular a parking area.

The motor vehicle AVP system of the method according to the first aspect is the AVP system for a motor vehicle according to the third aspect. This means that the AVP system according to the third aspect can be referred to as a motor vehicle AVP system if it is implemented in a motor vehicle.

A method in the sense of the description is carried out, for example, by way of the corresponding AVP system.

FIG. 1 shows a flowchart of a method for at least highly automated driving of a motor vehicle within a parking area using a motor vehicle AVP system, wherein the motor vehicle can be operated in a first AVP operating mode, in which the motor vehicle drives in an at least highly automated manner according to AVP type 1, and in a second AVP operating mode, in which the motor vehicle drives in an at least highly automated manner according to AVP type 2. The AVP type 1 is a motor-vehicle-centric AVP process, and the AVP type 2 is an infrastructure-centric AVP process. The method shown in FIG. 1 comprises the steps of:

Operating 101 the motor vehicle in the second AVP operating mode by way of the motor vehicle AVP system. The motor vehicle drives in an at least highly automated manner according to AVP type 2 within the parking area with the assistance of an infrastructure AVP system.

When a handover region of the parking area is reached by the motor vehicle, carrying out 103 a handover process by way of the motor vehicle AVP system in order to be able to switch the motor vehicle from the second AVP operating mode to the first AVP operating mode.

When the handover process has been successfully carried out, switching 105 from the second AVP operating mode to the first AVP operating mode by way of the motor vehicle AVP system.

After switching, operating 107 the motor vehicle in the first AVP operating mode by way of the motor vehicle AVP system, with the result that the motor vehicle drives in an at least highly automated manner according to AVP type 1 within the parking area.

Operating a motor vehicle in the first AVP operating mode and/or in the second AVP operating mode by way of the motor vehicle AVP system comprises, for example, at least highly automated control of lateral and longitudinal guidance of the motor vehicle by the motor vehicle AVP system, i.e. a taking over of the lateral and longitudinal guidance of the motor vehicle by the motor vehicle AVP system.

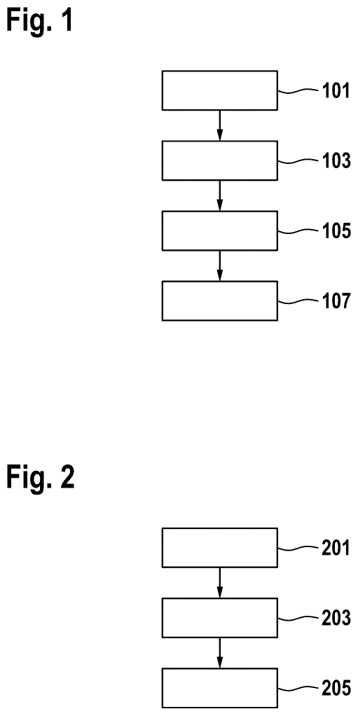

FIG. 2 shows a flowchart of a method for infrastructure-based assistance of a motor vehicle during an at least highly automated journey within a parking area using an infrastructure AVP system, wherein the motor vehicle can be operated in a first AVP operating mode, in which the motor vehicle drives in an at least highly automated manner according to AVP type 1, and in a second AVP operating mode, in which the motor vehicle drives in an at least highly automated manner according to AVP type 2. The AVP type 1 is a motor-vehicle-centric AVP process and the AVP type 2 is an infrastructure-centric AVP process. The method comprises the steps of:

Assisting 201 the motor vehicle on the infrastructure side by way of the infrastructure AVP system in order to operate the motor vehicle in the second AVP operating mode, with the result that the motor vehicle can drive in an at least highly automated manner according to AVP type 2 within the parking area with the assistance of the infrastructure AVP system.

When a handover region of the parking area is reached by the motor vehicle, carrying out 203 a handover process by way of the infrastructure AVP system in order to be able to switch the motor vehicle from the second AVP operating mode to the first AVP operating mode.

If the handover process has been successfully carried out, sending 205 a specification to the motor vehicle by way of the infrastructure AVP system indicating that the motor vehicle is intended to continue to drive in an at least highly automated manner according to AVP type 1, with the result that the motor vehicle may switch from the second AVP operating mode to the first AVP operating mode and can be operated in the first AVP operating mode after switching, with the result that the motor vehicle can drive in an at least highly automated manner according to AVP type 1 within the parking area.

Assisting the motor vehicle on the infrastructure side by way of the infrastructure AVP system comprises, for example, sending infrastructure assistance data to the motor vehicle. Infrastructure assistance data comprise, for example, a target trajectory to be driven along by the motor vehicle. Infrastructure assistance data comprise, for example, a drive command. Infrastructure assistance data comprise, for example, an object list of objects located in the environment of the motor vehicle. Infrastructure assistance data comprise, for example, a digital environmental model of an environment of the motor vehicle. Infrastructure assistance data comprise, for example, environmental data that represent or describe the environment of the motor vehicle.

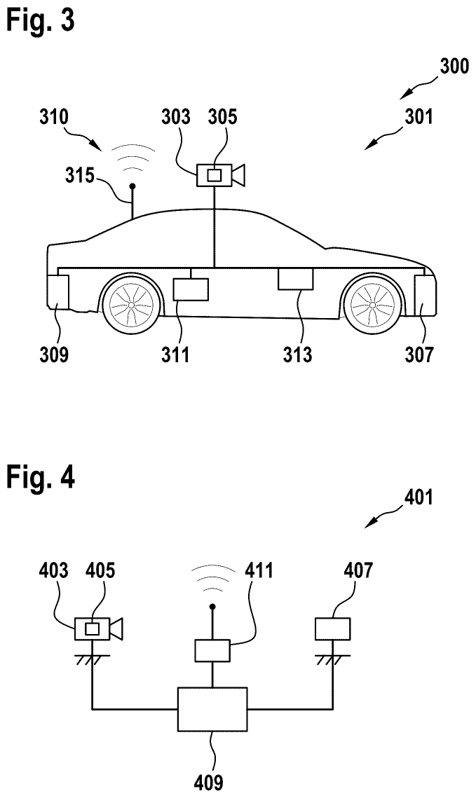

FIG. 3 shows a motor vehicle AVP system 300 according to the third aspect, which is included in a motor vehicle 301 according to the fourth aspect. The AVP system 300 is configured to carry out all the steps of the method according to the first aspect.

By way of example, the motor vehicle AVP system 300 comprises a video camera 303 comprising an image sensor 305. The video camera 303 is arranged on the roof of the motor vehicle 301.

The motor vehicle AVP system 300 further comprises, by way of example, a first radar sensor 307 which is arranged on the front of the motor vehicle 301. The motor vehicle AVP system 300 further comprises, by way of example, a second radar sensor 309 which is arranged on the rear of the motor vehicle 301. The motor vehicle AVP system 300 further comprises, by way of example, an ultrasonic sensor 311 which is arranged on the side of the motor vehicle 301.

Thus, the motor vehicle AVP system 300 comprises a motor vehicle environmental sensor system comprising multiple environmental sensors: image sensor 305, radar sensors 307, 309, and ultrasonic sensor 311. These environmental sensors capture an environment of the motor vehicle and output environmental sensor data based on the capture to a control unit 313 of the motor vehicle AVP system 300. The control unit 313 processes these environmental sensor data in order to guide the motor vehicle in an at least highly automated manner.

The motor vehicle AVP system 300 further comprises a wireless communication interface 315 which is configured to communicate with an infrastructure AVP system. Communication in the sense of the present description comprises sending and receiving. It is noted that more or fewer and/or other environmental sensors can be provided instead of or in addition to the environmental sensors shown in FIG. 3.

In an embodiment, provision is made for the motor vehicle AVP system 300 to not comprise any motor vehicle environmental sensors. In this case, the motor vehicle environmental sensors are already part of the motor vehicle 301.

FIG. 4 shows an AVP system 401 for an infrastructure, in particular a parking area. The infrastructure AVP system 401 is configured to carry out all the steps of the method according to the second aspect. By way of example, the AVP system 401 comprises a video camera 403 comprising an image sensor 405. By way of example, the AVP system 401 comprises a radar sensor 407.

These environmental sensors 405, 407 are spatially distributed within a parking area and each capture a region of the parking area. Environmental sensor data based on the capture from these environmental sensors 405, 407 are output to a data processing device 409 which processes the environmental sensor data and, for example based thereon, determines infrastructure assistance data for assisting an at least highly automated motor vehicle during an AVP process. In other embodiments, more or fewer and/or other environmental sensors can be provided instead of or in addition to the environmental sensors shown in FIG. 4.

The infrastructure AVP system 401 further comprises a wireless communication interface 411 which is configured to communicate with one or more at least highly automated motor vehicles which are located within the parking area. For example, the AVP system 401 comprises a plurality of such wireless communication interfaces 411 which are spatially distributed within the parking area in order to achieve sufficient radio coverage.

The data processing device 409 may comprise, for example, one or more servers, one or more of which, for example, can be implemented in a cloud infrastructure. In another embodiment, provision is made for the AVP system 401 to not comprise any infrastructure environmental sensors. In this case, the infrastructure environmental sensors are already part of the parking area.

The region of the parking area within which the motor vehicle is intended to drive or drives according to AVP type 1 is not equipped, in particular, with such infrastructure environmental sensors.

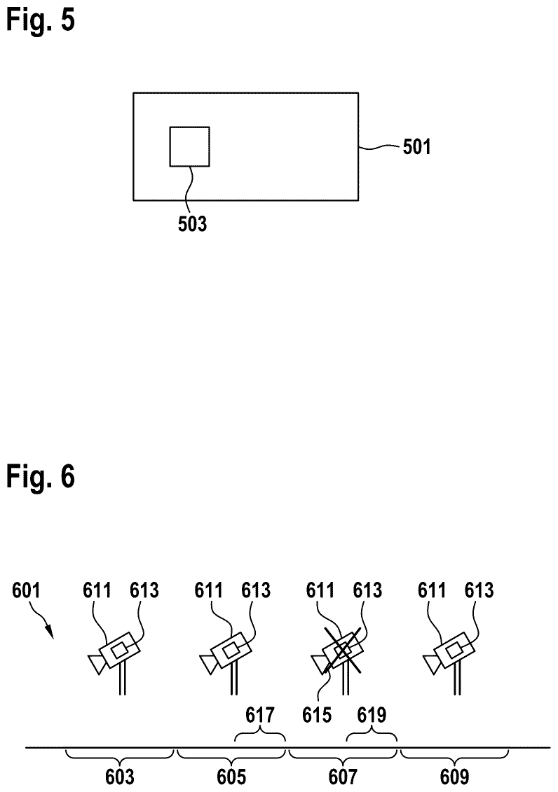

FIG. 5 shows a machine-readable storage medium 501 according to the sixth aspect, on which a computer program 503 according to the fifth aspect is stored. The machine-readable storage medium 501 is a non-transitory machine-readable storage medium.

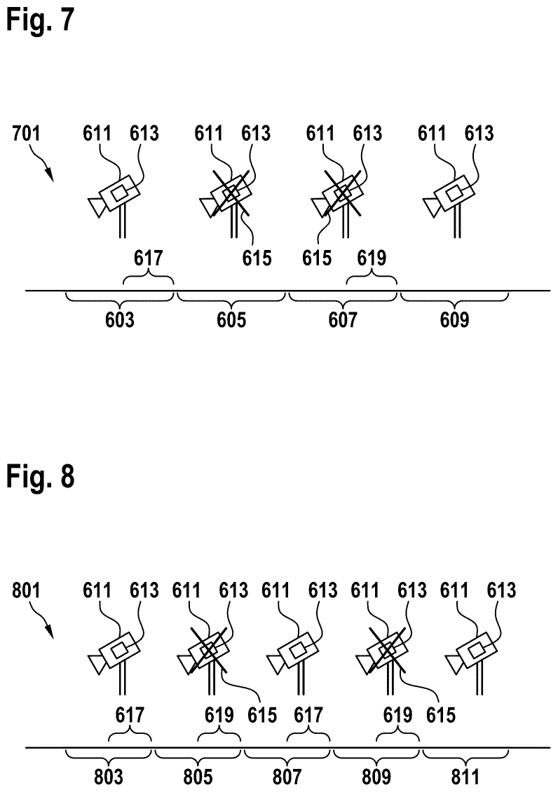

FIGS. 6 to 8 each show a parking area. In detail, FIG. 6 shows a first parking area 601. FIG. 7 shows a second parking area 701. FIG. 8 shows a third parking area 801.

A plurality of regions are determined or defined within these three parking areas 601, 701, 801, wherein an at least highly automated motor vehicle is intended to drive within these regions during an AVP process either according to AVP type 1 or according to AVP type 2. Four such areas are defined for the parking areas 601, 701 according to FIGS. 6 and 7: a first region 603, a second region 605, a third region 607 and a fourth region 609, which are each arranged directly adjacent to one another in succession.

The first region 603 marks a drop zone of the parking area 601 and 701. At the drop zone 603, a driver of his motor vehicle drops off his motor vehicle or parks it within this zone. The AVP process starts at the drop zone.

During the AVP process, the motor vehicle is intended to park, for example, within the fourth region 609, since this marks a parking place of the parking area 601 or 701 according to the exemplary embodiments shown here.

A second region 605 and a third region 607 are thus defined between the drop zone and the parking place.

Five regions are determined or defined for the third parking area 801 according to FIG. 8: a first region 803, a second region 805, a third region 807, a fourth region 809 and a fifth region 811.

The first region 803 marks a drop zone of the third parking area 801. The fifth region 811 marks a parking place of the third parking area 801.

The second region 805, the third region 807 and the fourth region 809 are defined between the first region 803 and the fifth region 811. The five regions 803 to 811 are each arranged directly adjacent to one another.

FIGS. 6 to 8 each depict a plurality of video cameras 611 each comprising an image sensor 613. In detail, such a video camera 611 is depicted for each of the regions shown in FIGS. 6 to 8. At this point, it is noted that other and/or further environmental sensors can be provided instead of or in addition to the video camera 611.

The video cameras 611 shown are intended to symbolize that there is or is not monitoring by infrastructure environmental sensors for the corresponding region. If there is no such monitoring, the video camera 611 shown accordingly is crossed with an “X” with the reference sign 615. Within those regions for which infrastructure monitoring by infrastructure environmental sensors is not provided, the motor vehicle is intended to drive during the AVP process according to AVP type 1. For the other regions, the motor vehicle is intended to drive according to AVP type 2.

As part of the concept described here, provision is made, before switching from one AVP operating mode to the other AVP operating mode, for a handover process to be carried out when a handover region is reached.

The reference sign 617 denotes a first handover region which is still included in a region within which the motor vehicle is intended to drive according to AVP type 2, that is to say a region for which there is monitoring by infrastructure environmental sensors. When the first handover region 617 is reached, a handover process is carried out according to the statements above and/or below in order to switch from the second AVP operating mode to the first AVP operating mode.

The reference sign 619 denotes a second handover region which is included in a region within which the motor vehicle is intended to drive according to AVP type 1, that is to say for which there is no monitoring by infrastructure environmental sensors. Within the second handover region 619, a further handover process is carried out in a similar manner to a handover process corresponding to the first handover region in order to switch from the first AVP operating mode to the second AVP operating mode.

Thus, according to FIGS. 6 to 8, provision is made for the first handover region 617 to end at the transition from a region, within which the motor vehicle drives according to AVP type 2, to a directly adjacent region, within which the motor vehicle is intended to drive according to AVP type 1. Similarly, the second handover region ends at the transition or at the boundary between a region, within which the motor vehicle is intended to drive according to AVP type 1, and an adjacent region, within which the motor vehicle is intended to drive according to AVP type 2.

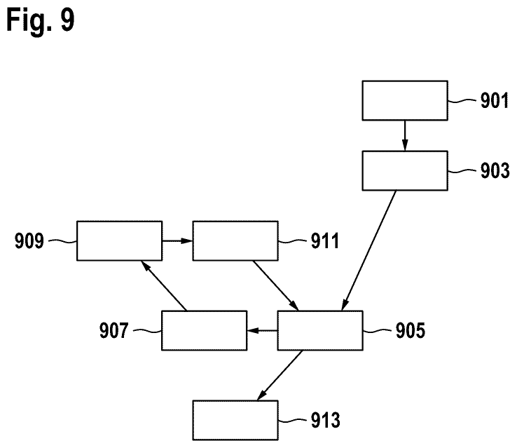

FIG. 9 shows a block diagram of an exemplary AVP process flow according to the concept described here.

According to a first function block 901, a request to carry out an AVP process for a motor vehicle within a parking area is provided. For example, instead of a request, another attempt at an AVP process that has already been started but is then stopped or paused may be provided. This means that, according to function block 901, for example, a driver of the motor vehicle can request an AVP process. This can also be carried out, for example, by the motor vehicle itself.

In a subsequent, second function block 903, an AVP initialization process is provided. After the AVP initialization process 903 has been successfully carried out, driving or operation of the motor vehicle according to AVP type 2 is provided according to a third function block 905. A fourth function block 907 follows, according to which a handover process is carried out when a handover region is reached. When the handover process 907 has been run through successfully, provision is made for the motor vehicle to be operated in the first AVP operating mode according to a fifth function block 909, with the result that the motor vehicle drives in an at least highly automated manner according to AVP type 1 within the parking area. When a further handover region is reached, a further handover process is provided according to a sixth function block 911, similarly to the fourth function block 907, in order to switch back to the second AVP operating mode. When the further handover process has been successfully carried out, the process is continued again at the third function block 905.

When a target position is reached, the AVP process ends according to a seventh function block 913. The AVP process ends, for example, when the motor vehicle has been parked or when it has reached a pick-up zone, for example, and has been parked there. A pick-up zone is generally a zone where a driver picks up his motor vehicle after the end of an AVP process.

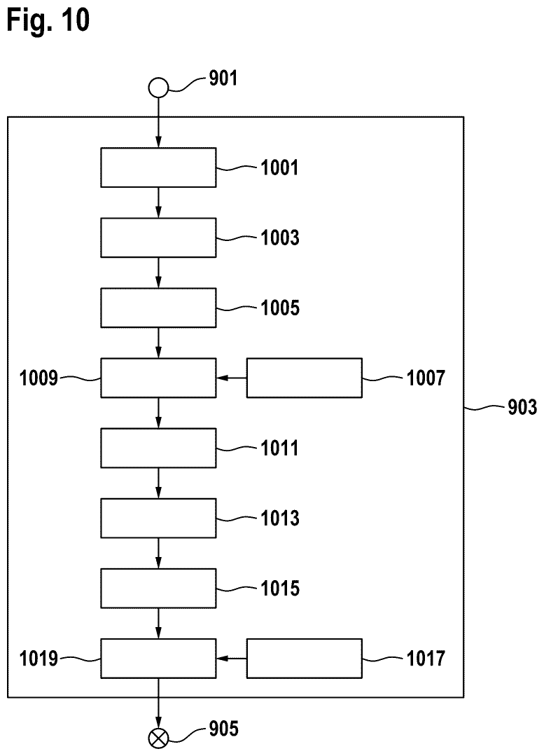

FIGS. 10 to 13 each show one of the processes illustrated in FIG. 9 by the individual function blocks in more detail.

FIG. 10 shows an exemplary AVP initialization process 903 in further detail.

The AVP initialization process 903 comprises a function block 1001, according to which a precondition check and a waking-up of the motor vehicle are carried out. Specifically, a motor vehicle backend tests or checks AVP preconditions with a motor vehicle AVP system 300 of the motor vehicle, which is intended to carry out the AVP process, and an operator backend. After these AVP preconditions have been successfully checked, the motor vehicle backend wakes up the motor vehicle. This wake-up means that the motor vehicle is started by the motor vehicle AVP system 300. A motor vehicle backend is a backend of the manufacturer of the motor vehicle. An operator backend is a backend of the operator of the infrastructure AVP system 401.

AVP preconditions comprise, for example, one or more of the following conditions: The motor vehicle must be approved for AVP and in particular for AVP type 1 and AVP type 2. The motor vehicle must be ready for the AVP process. Being ready means, in particular, that all the components of the motor vehicle required for the AVP process must be ready. Being ready means, in particular, that there is no fault or that no fault has occurred. The infrastructure AVP system must be ready for the AVP process. Being ready means, in particular, that all the components of the infrastructure AVP system 401 required for the AVP process must be ready. Being ready means, in particular, that there is no fault or that no fault has occurred.

Function block 1001 is followed by a function block 1003, according to which one or more motor vehicle certificates are exchanged. Specifically, a motor vehicle certificate or motor vehicle certificates is or are exchanged between the motor vehicle AVP system 300 or motor vehicle backend and the operator backend. The operator backend can gain access to one or more motor vehicle components using these certificates, for example.

There follows a function block 1005, according to which a connection to the infrastructure AVP system 401 is established by the motor vehicle AVP system 300. Specifically, the motor vehicle AVP system 300 connects wirelessly to the infrastructure system on the infrastructure side.

According to a function block 1007, the infrastructure AVP system 401 sends a digital map of the parking area to the motor vehicle so that the motor vehicle AVP system can reliably locate the motor vehicle within this map. According to function block 1009, such localization on the motor vehicle side is provided.

Specifically, the motor vehicle is located within the digital map by the motor vehicle AVP system 300, in particular certainly, i.e. reliably, in order to determine a current pose of the motor vehicle based on the digital map. This current pose determined on the motor vehicle side is sent by the motor vehicle AVP system 300 to the infrastructure AVP system 401.

The infrastructure AVP system 401 checks or tests the current pose sent by the motor vehicle, for example by locating the motor vehicle itself.

Furthermore, according to function block 1009, provision is made for the infrastructure AVP system 401 to identify the motor vehicle based on the current pose determined on the motor vehicle side and the current pose of the motor vehicle determined on the infrastructure side. This means that, if the two poses match, the motor vehicle has been correctly or successfully identified from the point of view of the infrastructure AVP system 401. The infrastructure AVP system 401 sends a confirmation of successful identification to the motor vehicle.

According to a subsequent function block 1011, provision is made for access tokens to be coordinated. Specifically, this means that the motor vehicle checks the coordination permit.

After successful motor vehicle identification, the OEM backend (motor vehicle backend) generates the token for the coordination authorization.

The token is passed on to the motor vehicle, both directly from the OEM backend to the motor vehicle and via the OEM backend to the AVP backend and from the latter directly or indirectly on to the motor vehicle. Indirect means that the token is, for example, passed on to a parking area management system of the parking area and from there on to the infrastructure AVP system 401 and from there on to the motor vehicle. The motor vehicle compares both tokens. This is used to confirm that it is connected to the correct infrastructure. The successful comparison is reported back directly from the motor vehicle to the OEM backend via the same channel that was used by the motor vehicle to receive the token.

In a subsequent function block 1013, a time synchronization is carried out between the motor vehicle AVP system 300 and the infrastructure AVP system 401, i.e. a clock comparison, so to speak.

According to a subsequent function block 1015, provision is made for the infrastructure AVP system 401 to check whether the motor vehicle can drive away without a collision.

Specifically, this means that the infrastructure AVP system 401 uses one or more infrastructure environmental sensors to check an environment of the motor vehicle with regard to driving away without a collision.

Only when the motor vehicle can drive away without a collision does the infrastructure AVP system 401 send a first driving permit according to a function block 1017, with the result that the motor vehicle AVP system 300 switches the motor vehicle to the second AVP operating mode according to a function block 1019, with the result that the motor vehicle drives away in an at least highly automated manner according to AVP type 2, in particular from the drop zone.

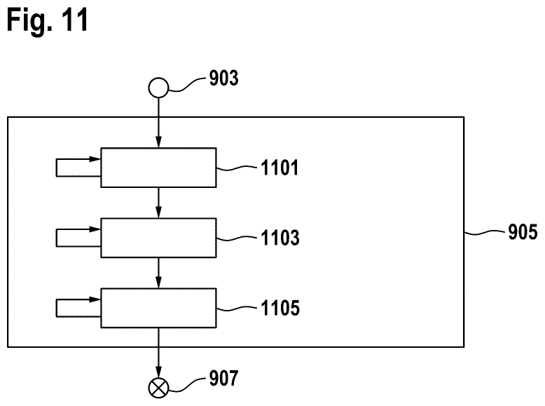

FIG. 11 shows driving according to AVP type 2 in detail.

According to a function block 1101, provision is made for the motor vehicle AVP system 300 to locate the motor vehicle while it drives in an at least highly automated manner according to AVP type 2 within the parking area. This localization is carried out continuously, in particular.

According to function block 1101, provision is also made for the infrastructure AVP system 401 to locate the motor vehicle, in particular continuously, during the at least highly automated journey according to AVP type 2.

Based on the localization on the infrastructure side, the infrastructure AVP system 401 can check, according to a function block 1103 following function block 1101, whether the target trajectory specified to the motor vehicle is complied with. Thus, based on the localization on the infrastructure side, the AVP system 401 can check whether an actual trajectory of the motor vehicle matches a target trajectory. This target trajectory was planned by the infrastructure AVP system 401.

According to a function block 1105, which follows function block 1103, provision is made for the motor vehicle AVP system 300 to carry out a time synchronization with the infrastructure AVP system 401, in particular continuously.

The motor vehicle follows the driving specifications of the infrastructure system, i.e. the infrastructure AVP system 401.

Since the motor vehicle AVP system 300 locates the motor vehicle while the motor vehicle is driving in an at least highly automated manner according to AVP type 2 within the parking area, it can be detected on the motor vehicle side when the motor vehicle reaches the handover region. Function blocks 1101, 1103 and 1105 are continuously performed until the motor vehicle has reached the handover region.

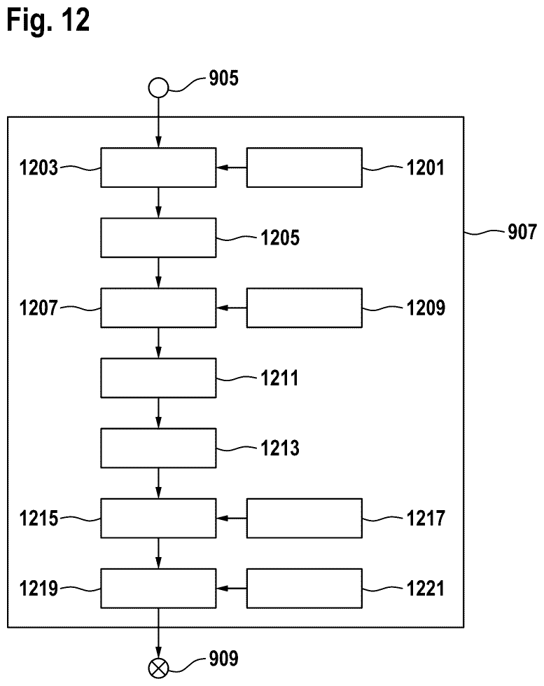

When the handover region is reached, the handover process 907 is provided. FIG. 12 shows the handover process in detail.

As already explained, the reaching of the handover region, for example reference signs 617 and 619 in the exemplary embodiments above, is detected according to a function block 1201 by the motor vehicle AVP system 300 of the motor vehicle. This is based on the localization on the motor vehicle side. Thus, according to a further function block 1203, it is determined that the motor vehicle has reached the handover region.

In a subsequent function block 1205, the motor vehicle AVP system 300 tests or checks handover preconditions. If checking is successful, the motor vehicle AVP system 300 requests switching from the infrastructure AVP system 401 according to a subsequent function block 1207. This means that the motor vehicle AVP system 300 sends a switching request 1209 to the infrastructure AVP system 401.

The infrastructure AVP system 401 checks the handover preconditions in response to the switching request 1209 according to a function block 1211. If checking is successful, provision is made, according to a further function block 1213, for the infrastructure AVP system 401 to determine a target position for the motor vehicle and to determine a proposal of a route to this target position. The determined proposal and the determined target position are sent from the infrastructure AVP system 401 to the motor vehicle according to function block 1213.

According to function block 1215, provision is made for the infrastructure AVP system 401 to then confirm the switching. Specifically, the infrastructure AVP system 401 sends a switching confirmation 1217 to the motor vehicle.

After sending the switching confirmation 1217, provision is made for the infrastructure AVP system 401 to send, according to a further function block 1219, a specification 1221 to the motor vehicle, as regards the AVP operating mode according to which the motor vehicle is intended to continue to drive. For example, the specification may therefore be that the motor vehicle must continue to drive according to AVP type 2, i.e. it must not switch to the first AVP operating mode. Alternatively, the specification may be that the motor vehicle may switch, i.e. may continue to drive according to AVP type 1. In the latter case, switching is carried out and driving is carried out in an at least highly automated manner according to AVP type 1 in accordance with function block 909.

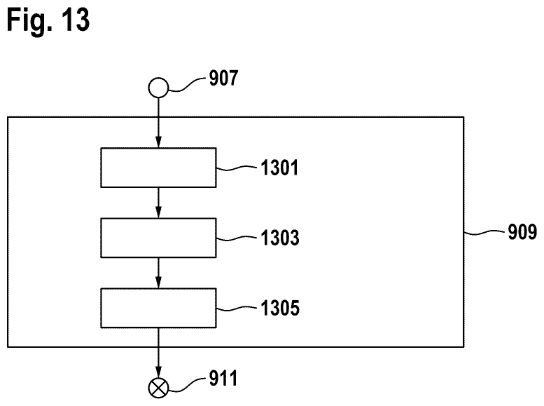

FIG. 13 shows the at least highly automated driving according to AVP type 1 in detail.

During the at least highly automated driving according to AVP type 1, provision is made, according to a function block 1301, for the motor vehicle AVP system to locate the motor vehicle, in particular continuously, within the parking area.

According to a function block 1303, provision is made for the motor vehicle AVP system 300 to guide the motor vehicle in an at least highly automated manner such that this follows, in particular accurately, the proposed route to the target position. If the motor vehicle AVP system 300 detects an obstacle on the proposed route using the motor vehicle's own environmental sensor system, provision is made, according to function block 1303, for the motor vehicle AVP system 300 to replan the originally proposed route and to continue to drive to the target position in an at least highly automated manner according to AVP type 1 based on the replanned route.

When a further handover region is reached, a further handover process is provided according to the sixth function block 911, similarly to the fourth function block 907, in order to switch back to the second AVP operating mode. When the further handover process has been successfully carried out, the process is continued again at the third function block 905.

According to a function block 1305, provision is made for the motor vehicle AVP system 300 to check the environment of the motor vehicle for potential obstacles using the motor vehicle's own environmental sensor system in order to avoid collisions with such obstacles.

In summary, the concept described here is based in particular on the fact that there are one or more regions within the parking area in which the motor vehicle is intended to drive or drives according to AVP type 1. An AVP process starts with at least highly automated driving according to AVP type 2. An AVP process ends with at least highly automated driving according to AVP type 2.

For example, no infrastructure environmental sensors are provided in the regions within which the motor vehicle is intended to drive according to AVP type 1. There is therefore no infrastructure monitoring within these regions. In these regions, the motor vehicle drives in a motor-vehicle-centric manner and thus drives without any assistance from the infrastructure.

A particular advantage of the concept described here is, in particular, that at any time exactly one party or one entity, i.e. either the motor vehicle or the infrastructure, i.e. either the motor vehicle AVP system or the infrastructure AVP system, holds the responsibility for the at least highly automated driving and thus implements this responsibility alone.

What is claimed is:

1. A method for driving a motor vehicle within a parking area, comprising:
providing the motor vehicle with a motor vehicle AVP system, the motor vehicle can be operated in a first AVP operating mode, in which the motor vehicle drives in an at least highly automated manner according to an AVP type 1, and in a second AVP operating mode, in which the motor vehicle drives in an at least highly automated manner according to an AVP type 2, the AVP type 1 is a motor-vehicle-centric AVP process and the AVP type 2 is an infrastructure-centric AVP process;
operating the motor vehicle in the second AVP operating mode by way of the motor vehicle AVP system, with the motor vehicle driving according to the AVP type 2 within the parking area with the assistance of an infrastructure AVP system;
carrying out a handover process by way of the motor vehicle AVP system in order to switch the motor vehicle from the second AVP operating mode to the first AVP operating mode when a handover region of the parking area is reached by the motor vehicle;
switching from the second AVP operating mode to the first AVP operating mode by way of the motor vehicle AVP system when the handover process has been completed; and
operating the motor vehicle in the first AVP operating mode by way of the motor vehicle AVP system after switching, with the motor vehicle driving according to the AVP type 1 within the parking area.

2. The method of claim 1, wherein, before operating the motor vehicle in the second AVP operating mode, an AVP initialization process is carried out by the motor vehicle AVP system, the motor vehicle is switched to the second AVP operating mode after successful completion of the AVP initialization process.

3. The method of claim 2, wherein the AVP initialization process includes locating the motor vehicle with the motor vehicle AVP system in order to determine a current pose of the motor vehicle, the current pose of the motor vehicle is sent by the motor vehicle AVP system to the infrastructure AVP system, the infrastructure AVP system checks the pose of the motor vehicle to identify the motor vehicle, a confirmation of successful identification of the motor vehicle by the infrastructure AVP system must be received by the motor vehicle AVP system for a successful end of the AVP initialization process.

4. The method of claim 3, wherein a digital map of the parking area is received from the infrastructure AVP system by the motor vehicle AVP system, the motor vehicle AVP system determines the current pose of the motor vehicle within the digital map.

5. The method of claim 1, wherein, during driving according to the AVP type 2, the motor vehicle is continuously located by the motor vehicle AVP system and is driven according to the AVP type 2 on the basis of the continuously determined location.

6. The method of claim 5, wherein reaching the handover region is detected by the motor vehicle AVP system based on the continuously determined location.

7. The method of claim 1, wherein carrying out the handover process includes checking a handover precondition with the motor vehicle AVP system that must be fulfilled for switching, a switching request is sent to the infrastructure AVP system by the motor vehicle AVP system if checking is successful.

8. The method of claim 1, wherein carrying out the handover process includes receiving a target position and a proposal of a route to the target position from the infrastructure AVP system by way of the motor vehicle AVP system.

9. The method of claim 8, wherein, during driving according to the AVP type 1, an environment of the motor vehicle is captured using a motor vehicle environmental sensor system, and if an obstacle captured by the motor vehicle environmental sensor system is detected, the proposal of the route is replanned by the motor vehicle AVP system to avoid the obstacle and the motor vehicle is driven to the target position based on a replanned route.

10. The method of claim 1, wherein, at an end of the handover process, a specification from the infrastructure AVP system is received by the motor vehicle AVP system and followed by the motor vehicle AVP system, the specification indicates whether the motor vehicle continues driving according to the AVP type 1 or the AVP type 2.

11. A method for driving a motor vehicle within a parking area, comprising:
providing an infrastructure AVP system communicating with the motor vehicle, the motor vehicle can be operated in a first AVP operating mode, in which the motor vehicle drives in an at least highly automated manner according to an AVP type 1, and in a second AVP operating mode, in which the motor vehicle drives in an at least highly automated manner according to an AVP type 2, the AVP type 1 is a motor-vehicle-centric AVP process and the AVP type 2 is an infrastructure-centric AVP process;
assisting the motor vehicle with the infrastructure AVP system to operate the motor vehicle in the second AVP operating mode, with the motor vehicle driving according to the AVP type 2 within the parking area;
carrying out a handover process by way of the infrastructure AVP system in order to switch the motor vehicle from the second AVP operating mode to the first AVP operating mode when a handover region of the parking area is reached by the motor vehicle;
sending a specification to the motor vehicle from the infrastructure AVP system that indicates driving according to the AVP type 1 when the handover process has been successfully completed;
switching from the second AVP operating mode to the first AVP operating mode at the motor vehicle; and
driving the motor vehicle according to the AVP type 1 within the parking area.

12. The method of claim 11, wherein, before assisting the motor vehicle, an AVP initialization process is carried out by the infrastructure AVP system, the infrastructure AVP system sends a first driving permit to the motor vehicle at a successful end of the AVP initialization process, the motor vehicle switches to the second AVP operating mode upon receiving the first driving permit.

13. The method of claim 12, wherein the AVP initialization process includes receiving at the infrastructure AVP system, from the motor vehicle, a current pose of the motor vehicle, the motor vehicle is located by the infrastructure AVP system to determine a current pose of the motor vehicle, the infrastructure AVP system compares the current pose determined by the infrastructure AVP system with the current pose determined by the motor vehicle to identify the motor vehicle, a confirmation of successful identification of the motor vehicle is sent by the infrastructure AVP system to the motor vehicle depending on the comparison.

14. The method of claim 13, wherein a digital map of the parking area is sent by the infrastructure AVP system to the motor vehicle, a position of the motor vehicle is identified on the digital map.

15. The method of claim 12, wherein the AVP initialization process includes checking with the infrastructure AVP system whether the motor vehicle can drive away without a collision, the first driving permit is sent only if it is possible to drive away without the collision.

16. The method of claim 11, wherein the handover process includes receiving a switching request from the motor vehicle at the infrastructure AVP system and, in response to receiving the switching request, the infrastructure AVP system checks a handover precondition which must be fulfilled for switching, a target position and a proposal of a route to the target position are determined by the infrastructure AVP system and sent to the motor vehicle if checking is successful.

17. The method of claim 11, wherein, in case of an unsuccessful end of the handover process, another specification is sent by the infrastructure AVP system to the motor vehicle indicating driving according to the AVP type 2.

18. A motor vehicle AVP system, which carries out the method of claim 1.

19. A motor vehicle comprising the motor vehicle AVP system of claim 18.

20. An infrastructure AVP system, which carries out the method of claim 11.

21. A computer program comprising a plurality of instructions which, when executed by a computer, cause the computer to carry out the method of claim 1.

22. A non-transitory machine-readable storage medium on which the computer program claimed in claim 21 is stored.
